(19) United States
(12) Patent Application Publication
(10) Pub. No.: US 2019/0034948 A1
(43) Pub. Date: Jan. 31, 2019

(54) Targeted Sensor Data Collection for Generating Map Information

(71) Applicant: Uber Technologies, Inc., San Francisco, CA (US)

(72) Inventors: Ryan A. Falor, Denver, CO (US); Elaine Yang, Boulder, CO (US); Peter B. Snajczuk, Denver, CO (US)

(21) Appl. No.: 16/046,744

(22) Filed: Jul. 26, 2018

Related U.S. Application Data
(60) Provisional application No. 62/539,343, filed on Jul. 31, 2017.

(51) Int. Cl. G06Q 30/02; G01C 21/28

(52) U.S. Cl. CPC G06Q 30/0208; G01C 21/28

(57) ABSTRACT

A network system uses a hybrid passive and active method for aggregating sensor data. The network system processes the sensor data to generate or update map information, which is used to coordinate geographic based services between users of the network system. In an embodiment, to leverage the idle time of users not actively providing services, the network system provides tasks for the users to collect sensor data for roads or points of interest (POIs) within a geographic region for which the network system is missing map information. The network system may determine that a user is more likely to complete a certain task if the target location for sensor data collection is nearby the user's current location. Thus, the network system is able to micro-target users with specific tasks, resulting in a greater likelihood of efficiently matching tasks to users.

### CROSS-REFERENCE TO RELATED APPLICATION

This application claims priority to U.S. Provisional Patent Application Ser. No. 62/539,343 filed on Jul. 31, 2017, which is incorporated by reference herein in its entirety for all purposes.

### BACKGROUND

### 1. Field

The present disclosure generally relates to generating map information using sensor data collected by users of a network system, and more specifically to determining tasks for the users to collect the sensor data.

### 2. Description of the Related Art

In a network system, providers provide geographic location-based services to users, for example, a provider (e.g., a driver) uses a vehicle to transport a user (e.g., a passenger). To provide navigation for these services, the network system may use map information received from third parties. The network system may also generate map information by collecting its own sensor data, but this process can be expensive and time consuming. For example, the network system deploys resources to instruct providers to drive their vehicles around to collect sensor data using their client devices. Since there is an extensive number of roads, many of which are remote or not frequently traveled, it is challenging to collect complete map information for a given geographical region and even more difficult at large scale such as covering multiple countries. Further, existing map information may become out-of-date and inaccurate when roads change due to construction, or when points of interest change.

### SUMMARY

A network system coordinates users who provide geographic location-based services to other users. As an example, providers provide transportation services to other users (e.g., trips for passengers) and the network system uses map information to provide routing instructions for providers to navigate between different locations in a geographic region. To generate the map information of the geographic region, the network system may use sensor data captured by providers' client devices or captured by other sensors equipped to a provider's vehicle. The network system may implement “passive collection,” that is, collecting the sensor data while client devices of providers are already traveling around during trips (e.g., while transporting a passenger from an origin to a destination). Additionally, the network system may use “active collection,” that is, assigning tasks for providers to travel to a target location or route to collect the desired sensor data via the client device. Though active collection can result in greater coverage of a geographic region (including less-traveled areas), it requires more resources than passive collection, which does not affect providers' available time to provide services.

The network system solves this problem by implementing a hybrid passive and active solution for aggregating sensor data at large scale over multiple geographic regions. In particular, providers who are not actively providing services may be idle and waiting for the next request for providing a service. To leverage the idle time of these providers, the network system provides tasks that the providers may select to complete in return for incentives. For example, the network system generates these tasks by determining certain roads, points of interest (POIs), or other sub-regions within a geographic region for which the network system will benefit from new or updated map information. The network system may determine that a provider is more likely to complete a certain task if the target location for sensor data collection is nearby the provider's current location, or en route to a subsequent trip. Thus, the network system is able to micro-target providers with specific tasks for improving map information, resulting in a greater likelihood of matching tasks to providers who will want to complete the tasks and can do so efficiently.

### BRIEF DESCRIPTION OF DRAWINGS

FIG. 1 is a diagram of a system environment for a network system according to one embodiment.

FIG. 2 is a block diagram illustrating the architecture of the network system according to one embodiment.

FIG. 3 is a diagram of map information of a geographical region according to one embodiment.

FIG. 4 is a diagram showing a mapping task for a target location within the geographical region shown in FIG. 3 according to one embodiment.

FIG. 5 is a flowchart illustrating a process for generating map information according to one embodiment.

FIG. 6 is a high-level block diagram illustrating physical components of a computer used as part or all of the components from FIG. 1, according to one embodiment.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### I. System Overview

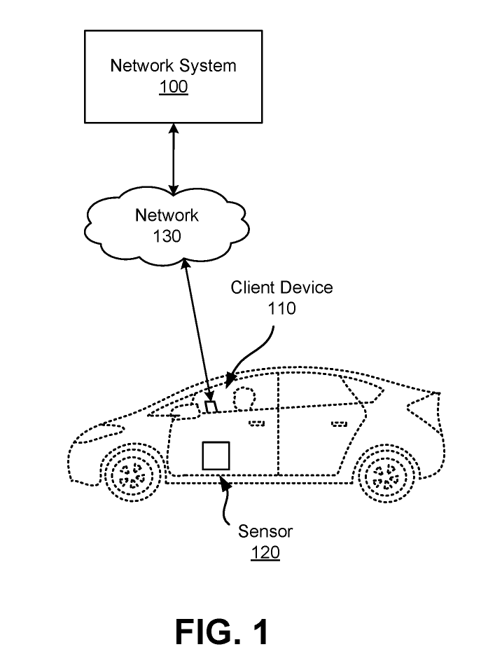

FIG. 1 is a diagram of a system environment for a network system 100 according to one embodiment. Users of the network system 100 may include providers that provide service to other users. Users may both receive service and provide service as providers of the network system 100. In an example use case, a provider operates a vehicle to transport a user from a first location, referred to herein as a “pickup location,” to a second location, referred to herein as a “destination location.” The network system 100 may determine pickup locations and coordinate providers to pick up users at the pickup locations. Other types of service include, for example, delivery of goods such as mail, packages, or consumable items. In addition to coordinating services between users, the network system 100 can also provide different tasks to providers or users. For example, the network system 100 provides mapping tasks for providers to collect sensor data, which the network system 100 uses to update a database of map information.

The system environment includes the network system 100 and one or more client devices 110 of users of the network system 100. The network system 100 and client devices 110 are connected to each other via a network 130. In other embodiments, different or additional entities can be included in the system environment. The functions performed by the various entities of FIG. 1 may vary in different embodiments.

A user can interact with the network system 100 through the client device 110, e.g., to request service, receive requests to provide service, or receive other types of tasks. A client device 110 can be a personal or mobile computing device, such as a smartphone, a tablet, or a notebook computer. In some embodiments, the client device 110 executes a client application that uses an application programming interface (API) to communicate with the network system 100 through the network 130. The client application of the client device 110 can present information on a user interface, such as a mapping task, map information, routing instructions, or a current location of the client device 110.

The client device 110 may include one or more sensors 120 such as a global positioning system (GPS) sensor, an imaging sensor, a motion sensor, an audio sensor, or other types of sensors. The client application running on the client device 110 can determine the current location of the client device 110 using signals from the GPS sensor. Imaging sensors include, e.g., cameras, radar sensors, light detection and ranging (LIDAR) sensors, and the like. In some embodiments, one or more of the sensors 120 is a standalone device not included in the client device 110. For instance, the sensor 120 may be a sensor pod mounted to a vehicle of a provider. The client device 110 may be communicatively coupled to a standalone sensor 120 to transmit information and provide captured sensor data to the network system 100 for further processing. In other embodiments, the client device 110 is not coupled to a standalone sensor 120, and instead, the standalone sensor 120 provides sensor data to network system 100 via the network 130 without using the client device 110. Motion sensors include, e.g., accelerometers, gyroscopes, magnetic sensors, inertial measurement units (IMUs), and the like. The motion sensors may capture telematics data describing motion or bearing of the user or a vehicle in which the user is traveling. In an example use case, the network system 100 processes sensor data captured by one or more sensors 120 to generate map information, navigation, or routing information, e.g., using shortest path algorithms known to one skilled in the art such as Dijkstra's algorithm.

In one embodiment, through operation of a client device of a user (e.g., a user desiring to be transported from an origin to a destination), the user requests service via the network system 100. A provider uses a client device 110 to interact with the network system 100 and receive invitations to provide service to users. For example, the provider is a person operating a vehicle capable of transporting users. In some embodiments, the provider is an autonomous vehicle that receives routing instructions from the network system 100. For convenience, this disclosure generally uses a car as the vehicle, which is operated by a driver as an example provider. However, the embodiments described herein may be adapted for a provider operating alternative vehicles (e.g., boat, airplane, helicopter, etc.) or vehicles that do not necessarily need to be operated by a person. In an example use case, the network system 100 selects a provider from a pool of available providers to provide a trip requested by a user. The network system 100 transmits an assignment request to the selected provider's client device 110.

Client devices 110 can communicate with the network system 100 via the network 130, which may comprise any combination of local area and wide area networks employing wired or wireless communication links. In one embodiment, the network 130 uses standard communications technologies and Internet protocols. For example, the network 130 includes communication links using technologies such as the Internet, 3G, 4G, BLUETOOTH®, or WiFi. In some embodiments, all or some of the communication links of the network 130 may be encrypted.

### II. Example System Architecture

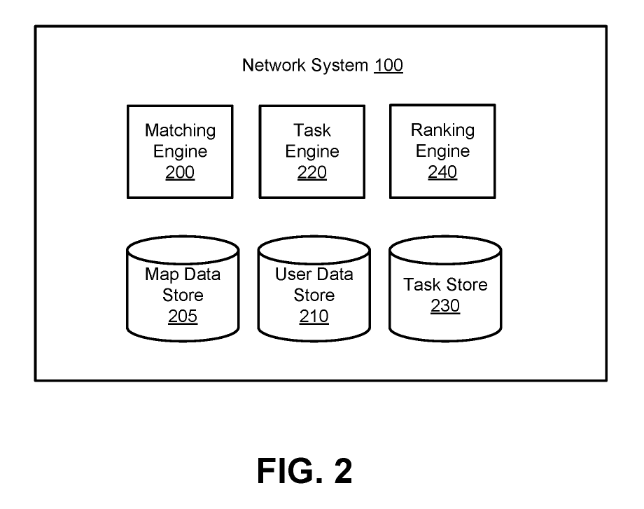

FIG. 2 is a block diagram illustrating the architecture of a network system 100 according to one embodiment. The network system 100 includes a matching engine 200, map data store 205, user data store 210, task engine 220, task store 230, and ranking engine 240. In other embodiments, the network system 100 may include additional, fewer, or different components for various applications. Conventional components such as network interfaces, security functions, load balancers, failover servers, management and network operations consoles, and the like are not shown as to not obscure the details of the system architecture.

In some embodiments, users and providers use their client devices 110 to register with the network system 100, for example, by creating accounts and providing user information (e.g., contact information, or a home or office address) to the network system 100. The network system 100 stores the user information in the user data store 210. The network system 100 can associate services received or provided, as well as completed (or incomplete) tasks by a user with the registered account of the user. For instance, the user data store 210 stores trip records indicating certain geographic regions or routes that the user has (or frequently) travels, or certain times of day that the user has interacted (or typically interacts) with the network system 100.

The map data store 205 stores map information of geographic regions in which the network system 100 offers services such as transportation for users. The map information may include map properties of a geographic region such as road properties that describe characteristics of the road segments, such as speed limits, road directionality (e.g., one-way or two-way), traffic history, traffic conditions, addresses on the road segment, length of the road segment, type of the road segment (e.g., surface street, residential, highway, or toll), predicted speeds (or predicted traversal times) along the road during given time periods, GPS data and/or geographic co-ordinates (e.g., latitude and longitude) associated with the road segment, etc. The map properties also can include properties about intersections, such as turn restrictions, light timing information, throughput, and connecting road segments. Further, the map information may describe POIs such as residential buildings, commercial buildings, stores or businesses located within a building (e.g., a mall or shopping center), or other types of locations. Map information may include images or other metadata associated with POIs or roads (e.g., an address or open hours of a POI). The network system 100 may use the map data store 205 to determine navigation information, tasks, pickup locations, or destination locations for services provided to users.

The matching engine 200 selects providers to service the requests of users. For example, the matching engine 200 receives a trip request from a user and determines a set of candidate providers that are online (e.g., running a client application on a client device 110 to interact with the network system 100), open (e.g., are available to transport a user), and within a threshold distance from a pickup location for the user. The matching engine 200 selects a provider from the set of candidate providers to which it transmits an assignment request. Specifically, the matching engine 200 may select a provider based on various factors, e.g., the provider's current location, the pickup or destination location, the type of the provider, the amount of time the provider has been waiting for an assignment request, or information about a mapping task that the provider is completing.

The task engine 220 coordinates tasks for completion by providers of the network system 100. In one embodiment, the task engine 220 generates mapping tasks based on map information from the map data store 205. For example, the task engine 220 determines that the stored map information for certain roads or sub-regions within a geographic region is missing, incomplete, or out-of-date. Thus, the task engine 220 generates a mapping task to collect sensor data for generating missing or incomplete map information, or for updating out-of-date map information. The network system 100 may aggregate the sensor data collected via client devices 110 of multiple providers performing mapping tasks to build a map of a geographic region. For example, a sensor of a first client device 110 collects sensor data of a segment of a highway, and another sensor of a second client device 110 collects sensor data of a local road following an exit of the segment of the highway. Thus, the network system 100 aggregates the sensor data from the two client devices to update road information, which the matching engine 200 may use to provide navigation or routing instructions. The task engine 220 may determine that map information is out-of-date or incorrect based on feedback received from providers or users, e.g., indicating that a road has closed or a new road has opened due to construction or that a POI no longer exists. In some embodiments, such feedback from users of the network system 100 may be provided to the network system via, for example, a mobile application associated with the network system 100 operating on client devices of the users. A mapping task may include a target location, e.g., a starting location for collecting sensor data along a specified route, or a discrete location at which to collect sensor data. Since a task may require a certain type of sensor 120 to collect the desired sensor data, the task engine 220 may determine whether a provider is eligible to complete the task based on information from the user profile store 205 (e.g., indicating the types of sensors 120 available on the provider's client device 110 or vehicle).

The task engine 220 stores tasks in the task store 230, which may be completed later by a provider of the network system 100. The task engine 220 may store tasks with a timestamp and determine that a given task is expired or “stale” responsive to determining that the given task has not been completed within a threshold of time. The task engine 220 may escalate a priority level of urgency of a task that is approaching a deadline or expiration. Responsive to determining that a provider has completed a given task, the task engine 220 may mark the given task as complete or remove the given task from the task store 230. In some embodiments, the task engine 220 determines that the provider started or completed a task based on input provided by the provider using a user interface of a client application on a client device 110. In other embodiments, the task engine 220 automatically determines that the provider started or completed a task using sensor data, e.g., determining that GPS traces captured by a sensor of the provider indicates that the provider is travelling along a specified route of the task. Additionally, the task engine 220 may track the progress of tasks, e.g., by determining that at a provider has completed a portion of a task but not the full task. The task engine 220 may provide the incomplete portions to a different provider to complete. The task engine 220 may generate and update reputation scores that indicate providers' performances in completing tasks. In some embodiments, providers who frequently complete tasks in full have greater reputation scores than providers who often do not fully complete—or incorrectly complete—tasks. The task engine 220 may store reputation scores in the user data store 210 associated with the account of the corresponding provider.

The task engine 220 provides candidate tasks to available provider, and responsive to receiving a selection of a candidate task from a provider, the task engine 220 provides instructions for completing the selected task for presentation on the provider's client device 110. In addition, the task engine 220 may determine incentives for the candidate tasks, where the network system 100 provides an incentive to a provider in return for completing the corresponding task. Incentives may include monetary compensation, vouchers, complementary services, or other types or combinations of rewards. The task engine 220 may determine the incentives based on one or more factors, e.g., a distance from the current location of a provider to the target location of candidate task, a distance that the provider needs to travel for completing the mapping task, a level of urgency of the candidate task, a provider's reputation score, among other parameters. For instance, the task engine 220 may determine an incentive based on an opportunity cost of the provider, e.g., compensation that the provider can receive by providing services over a duration of time instead of completing a task. As another example, the task engine 220 may determine an incentive based on a level of novelty of the candidate task. Specifically, collecting sensor data of a remote area has greater level of novelty than collecting sensor data within a well-populated urban area (or an area in which users often request transportation services) because providers or users travel to the former less often. Thus, the task engine 220 may determine a greater incentive for tasks having a greater level of novelty. In some embodiments, the task engine 220 determines incentives that a provider can earn by completing a threshold number of tasks within a predetermined duration, and can provide various tiers of incentives (e.g., where the value of the incentive increases as the provider completes additional tasks).

In one use case, the task engine 220 determines that a provider is online and available because the provider is waiting to receive a service request. The task engine 220 provides one or more candidate tasks for presentation on the provider's client device 110. Rather than further waiting to receive a service request, the provider may decide to complete one or more of the candidate tasks to earn the associated incentive. To increase the likelihood that the provider will select one of the candidate tasks, the task engine 220 may provide candidate tasks scored and ranked by the ranking engine 240, as described in more detail below.

The ranking engine 240 ranks tasks by generating scores indicating the likelihood that a provider will select, or complete, the corresponding task. The ranking engine 240 may generate scores based on various factors, including those used by the task engine 220 to determine incentives as previously described (e.g., travel distance, opportunity cost, reputation score, level of urgency, or level of novelty), and other factors such as whether a provider previously started or completed a certain type of task in a relevant geographic region and/or during a recent time period. Additionally, the ranking engine 240 may generate scores on a per-provider basis while providers are interacting with the network system 100, e.g., while a provider is operating a vehicle to provide transportation service. In some use cases, the ranking engine 240 ranks tasks as a provider is completing a previous task or service provided to a user (e.g., during the last pre-determined duration of time or distance of the task or service such as a trip). The ranking engine 240 may also generate scores while a provider is idle or offline, where the ranking engine 240 retrieves these scores when the provider goes online via a client device 110.

In some embodiments, the ranking engine 240 generates a score for a task that is proportional to a value of the incentive because providers are more likely to select tasks with greater incentives. Further, a task that needs to be completed during a certain time window has a greater score during the time window, e.g., capturing an image of POI during daylight hours when there is more visibility in comparison to nighttime hours. As another example, the ranking engine 240 may generate greater scores for providers who have completed at least a threshold number of tasks (e.g., within a given time period) according to the providers' reputation scores, relative to other providers who seldom complete tasks. In some embodiments, the ranking engine 240 provides a task to incentive a provider to take a detour from a navigation route. For example, the provider follows the navigation route to travel from an origin location to a destination location, and the detour deviates from the navigation route so that the provider may collect sensor data from a location nearby (though not exactly along) the navigation route. By scoring and ranking tasks, the ranking engine 240 may help the network system 100 cycle through the tasks scored in the task store 230 and avoid having tasks becoming stale or expired. Encouraging providers to promptly complete tasks is advantageous because the network system 100 can use the collected sensor data to generate new map information or update existing map information, which may improve the quality or variety of services provided via the network system 100.

In some embodiments, the ranking engine 240 initially scores “easy” tasks (e.g., requiring a relatively shorter distance of travel or having a target location nearby a provider's current location) greater than “difficult” tasks (e.g., requiring a relatively longer distance of travel or having a target location far away a provider's current location) for a provider. However, as the provider successfully completes “easy” tasks, the provider's reputation score may increase, and thus the ranking engine 240 may begin to rank “difficult” tasks more favorably. In other words, the ranking engine 240 determines that the provider is more likely to select “difficult” tasks responsive to determining the provider has established a reputation of completing “easy” tasks.

In some embodiments, the ranking engine 240 implements a hybrid passive and active system for determining and providing tasks to providers. For example, during “passive” collection of sensor data from client devices 110 of providers providing services, the network system 100 determines that map information for a given geographic region is missing or out-of-date. For instance, GPS and/or motion data indicates that a client device 110 traveled to a road that does not exist in the current map information stored in the map data store 205, or feedback received from a provider or user via the client device 110 indicates that a certain road or POI included in the current map information actually does not exist anymore. Responsive to determining that the map information is missing or out-of-date, the ranking engine 240 determines “active” mapping tasks to rank and provide to providers. Further, the ranking engine 240 may reduce the number of “active” mapping tasks and transition to primarily “passive” sensor data collection responsive to determining that the latest map information for the given geographic region has at least a threshold level of quality, e.g., not missing road segments and not including inaccurate POI information such as building names, images, or addresses.

### III. Example Map of Target Locations

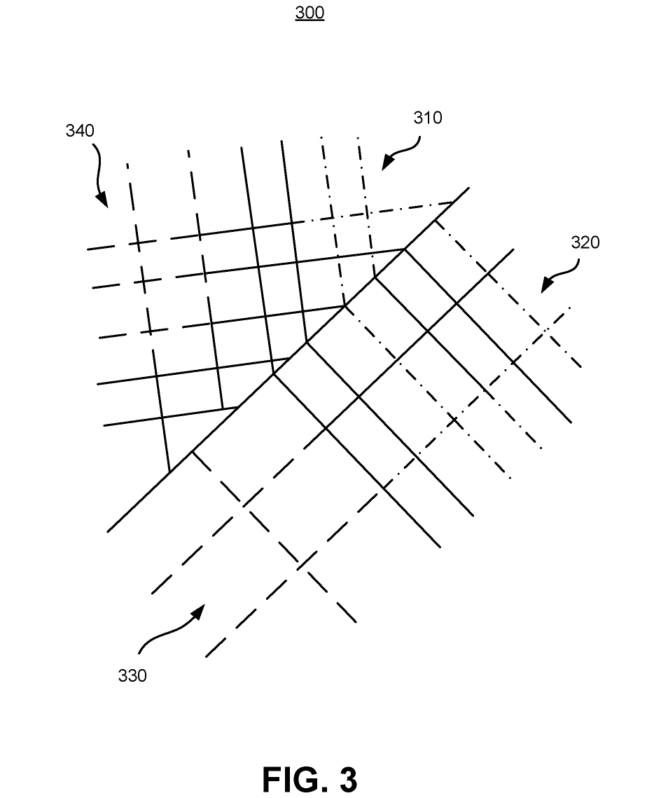

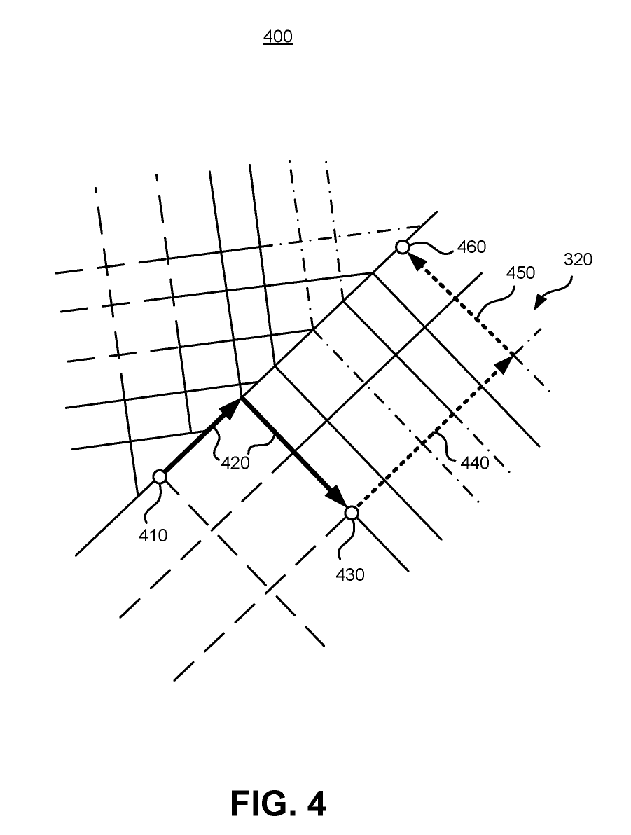

FIGS. 3-4 illustrate an example use case of providing a mapping task to collect sensor data for generating map information of a geographical region. FIG. 3 is a diagram 300 of map information of the geographical region according to one embodiment. In particular, the lines of the diagram 300 illustrate roads and intersections included in the map information stored in the map data store 205. In the example shown in FIG. 3, solid lines indicate that the map data store 205 includes complete map information for the corresponding road; dashed lines indicate that the map data store 205 includes partial map information for the corresponding road; and dashed-and-dotted lines indicate that the map data store 205 is missing map information for the corresponding road. Thus, the map data store 205 is missing map information for the upper right regions 310 and 320, and includes partial map information for the lower left region 330 and upper left region 340. In some embodiments, a client device 110 shows the status of available map information in a graphical user interface so that a provider can identify regions that are missing or have partial map information.

### IV. Example Mapping Task

FIG. 4 is a diagram 400 showing a mapping task for a target location within the geographical region shown in FIG. 3 according to one embodiment. Since map information is missing for the region 320, the task engine 220 generates a mapping task starting from the target location 430, traveling along the first road segment 440 and second road segment 450 (as indicated by the dotted line), and ending at location 460. When the client device 110 of a provider is at location 410, the ranking engine 240 generates a score indicating that the provider is likely to select the mapping task because the current location 410 is near the target location 430. In particular, the ranking engine 240 determines that the distance 420 between the current location 410 and the target location 430 is less than a threshold distance. In another embodiment, the location 410 indicates a destination location 410 of a trip provided by a provider. Thus, the ranking engine 240 determines that the provider is likely to start the mapping task shortly or immediately after completing the trip because the destination location 410 is near the target location 430. In other embodiments, instead of generating scores, the ranking engine 240 ranks mapping tasks based on various factors (e.g., distance from current location to a target location, task difficulty, or level of novelty of the task) and selects mapping tasks to provide to providers based on the ranking.

In some embodiments, the task engine 220 modifies the incentive of the mapping task responsive to determining that the provider did not complete at least a portion of the mapping task. For example, based on sensor data received from the provider's client device 110 or a sensor 120, the task engine 220 determines that the provider traveled (based on travel of the client device 110) along the first road segment 440 but did not travel along the second road segment 450 of the mapping task. Thus, the task engine 220 reduces the incentive received by the provider, e.g., based on a ratio of the distance of roads traveled to the total distance designated by the mapping task. In other words, the task engine 220 does not reward the provider for the portion of the mapping task that was not actually completed. Responsive to determining that the provider is deviating from a designated path indicated by the mapping task, the task engine 220 may provide a notification to the client device 110 to instruct the provider to return to the designated path in order to complete the other portions of the mapping task. In some embodiments, to increase the likelihood that the provider will complete the mapping task, the task engine 220 modifies (e.g., increases or decrease) an incentive of the mapping task responsive to determining that the provider deviated from the designated path. In some embodiments, the task engine 220 modifies incentives of mapping tasks for subsequent mapping tasks presented to a provider, or to other users, responsive to determining that the provider did not complete at least some portion of a mapping task. For example, to motivate the provider to complete the incomplete portion of the mapping task later, the task engine 220 increases the incentive when presenting the provider with the updated task and modified incentive. The subsequent mapping tasks may include the uncompleted portions of the mapping task.

### V. Example Process Flow

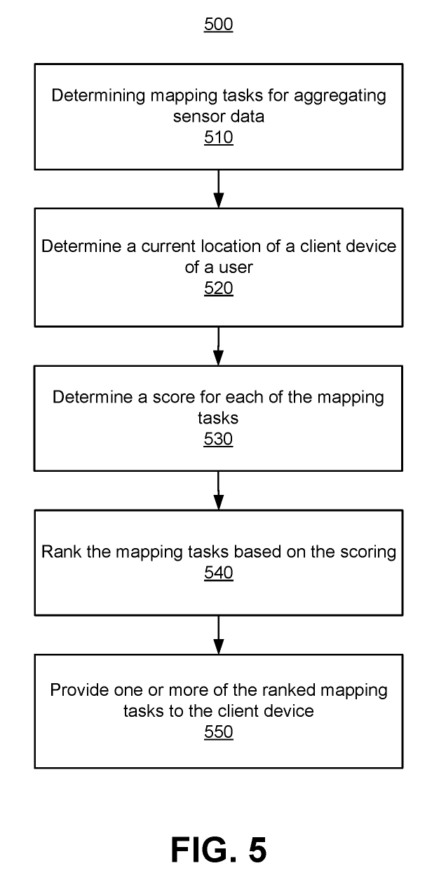

FIG. 5 is a flowchart illustrating a process for generating map information according to one embodiment. In some embodiments, the network system 100 uses the process 500 within the system environment in FIG. 1. The process 500 may include different or additional steps than those described in conjunction with FIG. 5 in some embodiments or perform steps in different orders than the order described in conjunction with FIG. 5.

In one embodiment, the task engine 220 determines 510 one or more mapping tasks for aggregating sensor data from client devices 110 of users of the network system 100, where the sensor data describes target locations within a geographical region. The network system 100 may use the aggregated sensor data to generate new map information or update existing map information. The task engine 220 determines 520 a current location of a client device 110 of a user (e.g., a provider) of the network system 100. For each of the mapping tasks, the ranking engine 240 determines 530 a score for the mapping task. In some embodiments, the score for a mapping task may be determined based at least in part on a distance from the current location determined in operation 520 to the target location corresponding to the given mapping task. The ranking engine 240 ranks 540 the mapping tasks for the user based on the scoring. The task engine 220 provides 550 one or more of the ranked mapping tasks to the client device 110 for presentation.

In some embodiments, the task engine 220 receives a selection of one of the presented mapping tasks from the client device 110. Additionally, the task engine 220 receives a sample of sensor data from the client device 110 or a sensor 120 of the user (e.g., a provider), where the sensor 120 captured the sample of sensor data while the user is completing the selected mapping task. For example, the sample of sensor data indicates position or motion data of the user's vehicle as the user travels from the target location and/or along road segments of the selected mapping task. The task engine 220 generates map information of the target location or road segments by processing the sample of sensor data and stores the map information in the map data store 205. For instance, by processing the position and motion data, the task engine 220 may determine a geometry of a road traveled by the user and the speeds at which the user traveled along the road. The generated map information may also include an image of a POI along the traveled road segments.

Though the above examples focus on mapping tasks, the embodiments described herein may also be adapted for other types of tasks. For example, the task engine 220 may generate tasks for a provider to deliver or pickup an item from a target location, which may not necessarily require a sensor 120 for sensor data collection. In some embodiments, the task engine 220 receives tasks from third parties to be provided to providers of the network system 100. Similar to tasks generated by the task engine 220, the received tasked may be associated with parameters such as target locations, incentives, or types of sensor data for collection, and may be stored in the task store 230. The task engine 220 may score and rank a heterogeneous set of mapping tasks by combining tasks generated by the task engine 220 and tasks received from third parties.

### VI. Example Physical Components of a Computer

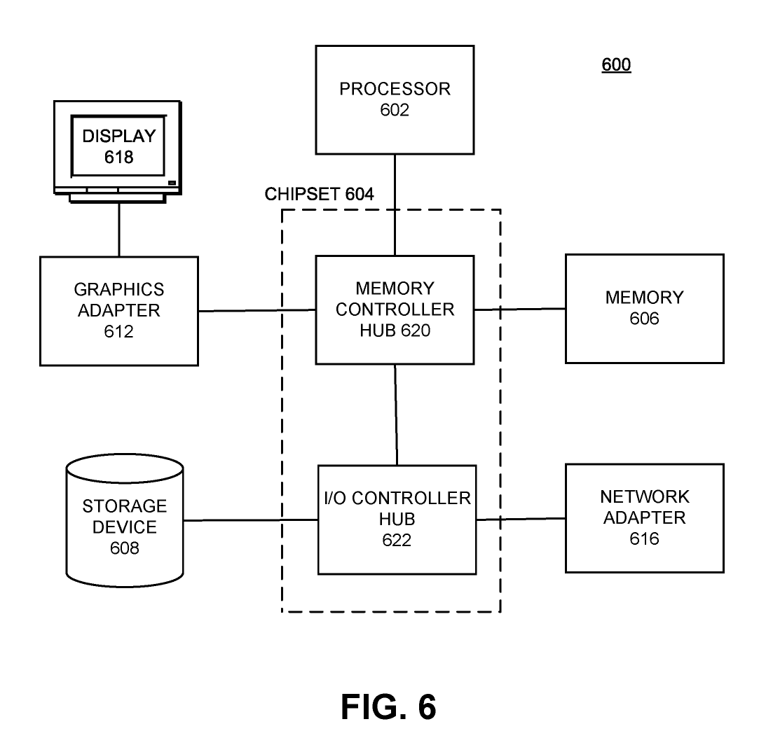

FIG. 6 is a high-level block diagram illustrating physical components of a computer 600 used as part or all of the components from FIG. 1 (e.g., the network system 100 or client devices 110), according to one embodiment. Illustrated are at least one processor 602 coupled to a chipset 604. Also coupled to the chipset 604 are a memory 606, a storage device 608, a graphics adapter 612, and a network adapter 616. A display 618 is coupled to the graphics adapter 612. In one embodiment, the functionality of the chipset 604 is provided by a memory controller hub 620 and an I/O controller hub 622. In another embodiment, the memory 606 is coupled directly to the processor 602 instead of the chipset 604.

The storage device 608 is any non-transitory computer-readable storage medium, such as a hard drive, compact disk read-only memory (CD-ROM), DVD, or a solid-state memory device. The memory 606 holds instructions and data used by the processor 602. The graphics adapter 612 displays images and other information on the display 618. The network adapter 616 couples the computer 600 to a local or wide area network.

As is known in the art, a computer 600 can have different and/or other components than those shown in FIG. 6. In addition, the computer 600 can lack certain illustrated components. In one embodiment, a computer 600 such as a server or smartphone may lack a graphics adapter 612, and/or display 618, as well as a keyboard or pointing device. Moreover, the storage device 608 can be local and/or remote from the computer 600, e.g., embodied within a storage area network (SAN).

As is known in the art, the computer 600 is adapted to execute computer program modules or engines for providing functionality described herein. As used herein, the terms “module” or “engine” refer to computer program logic utilized to provide the specified functionality. Thus, a module and/or engine can be implemented in hardware, firmware, and/or software. In one embodiment, program modules and/or engines are stored on the storage device 608, loaded into the memory 606, and executed by the processor 602.

### VII. Additional Configurations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product including a computer-readable non-transitory medium containing computer program code, which can be executed by a computer processor for performing any or all of the steps, operations, or processes described.

Embodiments of the invention may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for generating map information of a geographical region using sensor data, the method comprising:
determining, using one or more processors, a plurality of mapping tasks for aggregating sensor data from a plurality of client devices of users of a network system, the sensor data describing target locations within the geographical region;
determining, using the one or more processors, a current location of a client device of a user of the network system;
for each of the plurality of mapping tasks:
determining, using the one or more processors, a score for the mapping task based at least in part on a distance from the current location to the target location corresponding to the mapping task, the score indicating a likelihood that the user will complete the mapping task;
ranking, using the one or more processors, the plurality of mapping tasks for the user based on the scoring; and
providing one or more of the ranked plurality of mapping tasks to the client device for presentation.

2. The method of claim 1, further comprising:
receiving, from the client device, a selection of a mapping task of the one or more of the ranked plurality of mapping tasks;
receiving, from the client device, a sample of sensor data; and
generating map information of the target location corresponding to the selected mapping task by processing the sample of sensor data.

3. The method of claim 2, further comprising:
for each of the plurality of mapping tasks:
determining an incentive based on the distance and another distance to be traveled for completing the mapping task;
providing the incentive of the selected mapping task to the user responsive to determining based on the sample of sensor data that the user completed at least a portion of the selected mapping task.

4. The method of claim 3, wherein determining the incentive is further based on a level of urgency of the mapping task.

5. The method of claim 3, further comprising:
determining that the user did not complete at least another portion of the selected mapping task; and
reducing the incentive provided to the user based on the other portion of the selected mapping task not completed.

6. The method of claim 1, wherein determining the score is further based on a frequency at which other users of the network system have previously traveled to the target location.

7. The method of claim 1, further comprising:
updating a reputation score of the user based on determining whether the user completed all portions of the selected mapping task; and
wherein determining scores for subsequent mapping tasks for the user is further based on the reputation score of the user.

8. The method of claim 1, further comprising:
determining one or more types of sensors of a vehicle of the user; and
wherein determining the score for the mapping task is further based on determining whether the one or more types of sensors are capable of capturing a particular type of sensor data required for the mapping task.

9. The method of claim 1, further comprising:
determining a destination location of a trip being provided by the user; and
wherein determining the score for the mapping task is further based on another distance from the destination location to the target location corresponding to the mapping task.

10. A computer program product comprising a non-transitory computer readable storage medium having instructions encoded thereon that, when executed by one or more processors, cause the one or more processors to:
determine, using one or more processors, a plurality of mapping tasks for aggregating sensor data from a plurality of client devices of users of a network system, the sensor data describing target locations within the geographical region;
determine, using the one or more processors, a current location of a client device of a user of the network system;
for each of the plurality of mapping tasks:
determine, using the one or more processors, a score for the mapping task based at least in part on a distance from the current location to the target location corresponding to the mapping task, the score indicating a likelihood that the user will complete the mapping task;
rank, using the one or more processors, the plurality of mapping tasks for the user based on the scoring; and
provide one or more of the ranked plurality of mapping tasks to the client device for presentation.

11. The non-transitory computer readable storage medium of claim 10, having further instructions that when executed by the one or more processors cause the one or more processors to:
receive, from the client device, a selection of a mapping task of the one or more of the ranked plurality of mapping tasks;
receive from the client device, a sample of sensor data; and
generate map information of the target location corresponding to the selected mapping task by processing the sample of sensor data.

12. The non-transitory computer readable storage medium of claim 11, having further instructions that when executed by the one or more processors cause the one or more processors to:
for each of the plurality of mapping tasks:
determine an incentive based on the distance and another distance to be traveled for completing the mapping task;
provide the incentive of the selected mapping task to the user responsive to determining based on the sample of sensor data that the user completed at least a portion of the selected mapping task.

13. The non-transitory computer readable storage medium of claim 12, wherein determining the incentive is further based on a level of urgency of the mapping task.

14. The non-transitory computer readable storage medium of claim 12, having further instructions that when executed by the one or more processors cause the one or more processors to:
determine that the user did not complete at least another portion of the selected mapping task; and
reduce the incentive provided to the user based on the other portion of the selected mapping task not completed.

15. The non-transitory computer readable storage medium of claim 10, wherein determining the score is further based on a frequency at which other users of the network system have previously traveled to the target location.

16. The non-transitory computer readable storage medium of claim 10, having further instructions that when executed by the one or more processors cause the one or more processors to:
update a reputation score of the user based on determining whether the user completed all portions of the selected mapping task; and
wherein determining scores for subsequent mapping tasks for the user is further based on the reputation score of the user.

17. The non-transitory computer readable storage medium of claim 10, having further instructions that when executed by the one or more processors cause the one or more processors to:
determine one or more types of sensors of a vehicle of the user; and
wherein determining the score for the mapping task is further based on determining whether the one or more types of sensors are capable of capturing a particular type of sensor data required for the mapping task.

18. The non-transitory computer readable storage medium of claim 10, having further instructions that when executed by the one or more processors cause the one or more processors to:
determine a destination location of a trip being provided by the user; and
wherein determining the score for the mapping task is further based on another distance from the destination location to the target location corresponding to the mapping task.
